(19) United States
(12) Patent Application Publication
(10) Pub. No.: US 2022/0019270 A1
(43) Pub. Date: Jan. 20, 2022

(54) FOLDABLE DEVICE AND ELECTRONIC EQUIPMENT

(71) Applicant: SHENZHEN ROYOLE TECHNOLOGIES CO., LTD., Shenzhen (CN)

(72) Inventors: Shuai Su, Shenzhen (CN); Zhuping Hong, Shenzhen (CN); Wenjun Liu, Shenzhen (CN); Xiaofei Fan, Shenzhen (CN); Songya Chen, Shenzhen (CN)

(21) Appl. No.: 17/377,915

(22) Filed: Jul. 16, 2021

(30) Foreign Application Priority Data
Jul. 17, 2020 (CN) 202010695720.X

(51) Int. Cl. G06F 1/16

(52) U.S. Cl. CPC G06F 1/1681; G06F 1/1652; G06F 1/1616

(57) ABSTRACT

The present disclosure provides a foldable device, which includes a bendable mechanism and a shielding mechanism. The bendable mechanism includes a middle hinge assembly and a connecting hinge provided on the side portion of the middle hinge assembly. The shielding mechanism includes a fixing member connected to the middle hinge assembly and the shielding member arranged between the fixing member and the connecting hinge, when the bendable mechanism is in the bending and unbending process, the shielding member is rotated relative to the fixing member, the shielding member slides relative to the connecting hinge and at least a part of the shielding member covers the bendable mechanism. The present disclosure also provides an electronic device provided with a foldable device.

### CROSS-REFERENCE TO RELATED APPLICATIONS

This application claims priority to Chinese Patent Application No. 202010695720.X, filed with the Chinese Patent Office on Jul. 17, 2020, entitled “Foldable device and Electronic Equipment”, which is incorporated herein by reference in its entirety.

### TECHNICAL FIELD

The present disclosure relates to the field of flexible member support, and in particular to a foldable device supporting a flexible member and an electronic equipment (electronic device) provided with the foldable device.

### BACKGROUND ART

With the development of display equipment, a bendable and ultra-thin electronic display screen, that is, the flexible display screen has appeared. Compared with traditional display devices, flexible display screens have the advantages of being foldable and flexible, and are widely favored by consumers. The existing flat-panel support structure obviously cannot meet the demand, so the industry has developed a support structure that can meet the bending demand of the flexible display screen. Existing support structures that can meet the bending demand are usually composed of a plurality of hinges, and adjacent hinges are hinged by a mechanism such as a pin shaft to rotate relatively. The foldable device in the prior art usually does not have a covering mechanism on the side facing away from the flexible member, which cannot meet the dustproof requirements.

### SUMMARY

The present disclosure provides a foldable device with dustproof effect and electronic equipment provided with the foldable device.

A foldable device provided by the present disclosure includes a bendable mechanism and a shielding mechanism. The bendable mechanism includes a middle hinge assembly and a connecting hinge provided on the side portion of the middle hinge assembly. The shielding mechanism includes a fixing member connected to the middle hinge assembly and the shielding member arranged between the fixing member and the connecting hinge, when the bendable mechanism is in the bending and unbending process, the shielding member is rotated relative to the fixing member, the shielding member slides relative to the connecting hinge and at least a part of the shielding member covers the bendable mechanism.

The present disclosure also provides an electronic device, including a flexible member, a housing, and a foldable device. The foldable device includes a bendable mechanism and a shielding mechanism. the bendable mechanism includes a middle hinge assembly and a connecting hinge provided on a side portion of the middle hinge assembly, and the shielding mechanism includes a fixing member connected to the middle hinge assembly and a shielding member arranged between the fixing member and the connecting hinge. When the bendable mechanism is in a bending process and an unbending process, the shielding member rotates relative to the fixing member, the shielding member slides relative to a corresponding connecting hinge and at least a part of the shielding member covers the bendable mechanism. The housing includes a first frame and a second frame, the foldable device is disposed between the first frame and the second frame, the flexible member is disposed on the housing and the foldable device, and the flexible member is bent or unbent with the foldable device.

The foldable device of the electronic equipment of the present disclosure includes a bendable mechanism and a shielding mechanism. During the bending and unbending process of the bendable mechanism, the shielding mechanism slides relative to the bendable mechanism and covers the bendable mechanism. Since the shielding mechanism is arranged on the inner side of bending of the bendable mechanism and bent or unbent along with the bendable mechanism, it prevents dust and other impurities from entering the foldable device from the inner side of the bending.

### BRIEF DESCRIPTION OF DRAWINGS

In order to more clearly illustrate technical solutions in embodiments of the present disclosure, accompanying drawings which need to be used in the embodiments will be introduced briefly below. Apparently, the accompanying drawings in the description below merely show some embodiments of the present disclosure, and those ordinarily skilled in the art still could obtain other accompanying drawings in light of these accompanying drawings, without inventive efforts.

FIG. 1 is a schematic diagram of a three-dimensional structure of an electronic equipment in one of the embodiments of the present disclosure.

FIG. 2 is an exploded schematic diagram of the three-dimensional structure of the flexible member, the housing, the foldable device, and the supporting sheet of the electronic equipment in FIG. 1.

FIG. 3 is a schematic diagram of the three-dimensional structure of the foldable device in FIG. 2.

FIG. 4 is a schematic diagram of the three-dimensional structure of the foldable device in FIG. 3 from another perspective.

FIG. 5 is an exploded schematic diagram of the three-dimensional structure of the bendable mechanism and the shielding mechanism of the foldable device in FIG. 3.

FIG. 6 is an exploded schematic diagram of the three-dimensional structure of the bendable mechanism and the shielding mechanism of the foldable device in FIG. 4.

FIG. 7 is an exploded schematic diagram of the three-dimensional structure of the shielding mechanism in FIG. 5.

FIG. 8 is an exploded schematic diagram of the three-dimensional structure of the shielding mechanism in FIG. 7 from another perspective.

FIG. 9 is a perspective enlarged diagram of a partial structure of the shielding mechanism in FIG. 7.

FIG. 10 is a perspective enlarged diagram of the positioning member in FIG. 8.

FIG. 11 is an assembly schematic diagram of a partial three-dimensional structure of the shielding mechanism in FIG. 7.

FIG. 12 is a schematic diagram of the three-dimensional structure of the shielding mechanism in FIG. 11 from another perspective.

FIG. 13 is a sectional diagram taken along the line XIII-XIII in FIG. 3.

FIG. 14 is a sectional diagram taken along the line XIV-XIV in FIG. 3.

FIG. 15 is a perspective schematic diagram of the foldable device of one of the embodiments of the present disclosure in a bending state.

FIG. 16 is a perspective schematic diagram of the bending state of the shielding mechanism of the foldable device of one of the embodiments of the present disclosure.

FIG. 17 is a sectional diagram taken along line XVII-XVII in FIG. 15.

FIG. 18 is a sectional diagram taken along line XVIII-XVIII in FIG. 15.

FIG. 19 is a perspective schematic diagram of the electronic equipment of the present disclosure in a bending state.

### DETAILED DESCRIPTION OF EMBODIMENTS

Technical solutions in the embodiments of the present disclosure will be described clearly and completely below in combination with the accompanying drawings in the embodiments of the present disclosure, apparently, the embodiments described are merely some but not all embodiments of the present disclosure. Based on the embodiments of the present disclosure, all other embodiments obtained by those of ordinary skill in the art without inventive effort shall fall within the protection scope of the present disclosure.

In addition, the description of the following embodiments refers to the attached reference signs to illustrate specific embodiments that can be implemented in the present disclosure. The direction terms mentioned in the present disclosure, such as “upper”, “lower”, “front”, “rear”, “left”, “right”, “inner”, “outer” and “side”, merely refer to the directions in the attached drawings. Therefore, direction terms are used to better and more clearly explain and understand the present disclosure, rather than indicating or suggesting that related devices or elements have to be in the specific orientation or configured or operated in a specific orientation, therefore, they should not be construed as limitation to the present disclosure.

In the description of the present disclosure, it should be illustrated that, unless otherwise specifically regulated and defined, the terms “mount”, “link”, “connect”, and “provide” should be understood in a broad sense, for example, connection may be fixed connection, detachable connection, or integrated connection; it may be mechanical connection; it may be direct linking or indirect linking through an intermediate medium, and it also may be inner communication between two elements. For those ordinarily skilled in the art, specific meanings of the above-mentioned terms in the present disclosure could be understood according to specific circumstances.

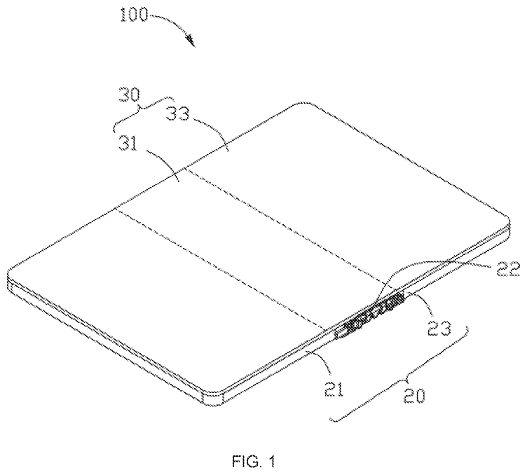

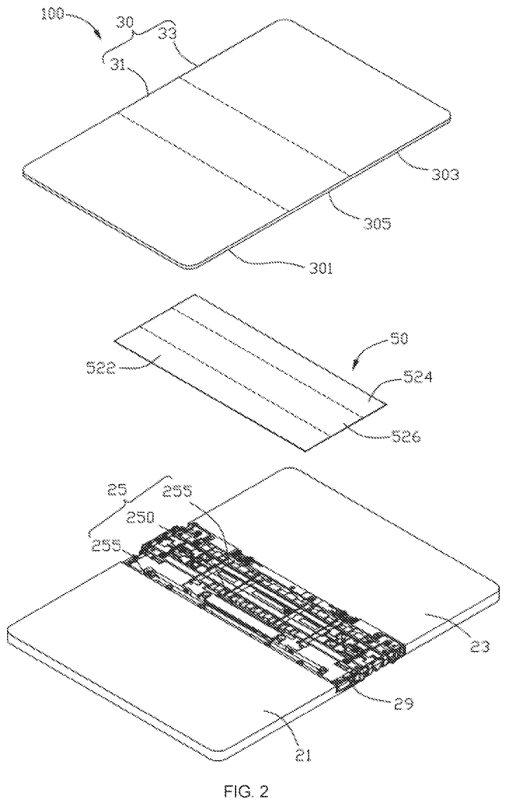

Please refer to FIGS. 1 to 6 together, the electronic equipment 100 in one of the embodiments of the present disclosure includes a housing 20, a foldable device 22, and a flexible member 30 disposed on the housing 20 and the foldable device 22. The flexible member 30 can be various flexible components with corresponding functions such as a flexible display screen, a flexible touch screen, and a flexible touch display screen, or a flexible component fixedly attached to a flexible supporting plate, such as a flexible display screen and a flexible touch screen attached to a flexible steel plate. The housing 20 includes a first frame 21 and a second frame 23. The foldable device 22 connects the first frame 21 and the second frame 23 and makes the first frame 21 and the second frame 23 rotate relatively, so as to bend or unbend the electronic equipment 100. The foldable device 22 includes a bendable mechanism 25 and a shielding mechanism 29. A supporting member 50 is attached to the front surface of the bendable mechanism 25, and the shielding mechanism 29 is arranged on the back surface of the bendable mechanism 25. In this embodiment, the supporting member 50 is a bendable supporting sheet, and the flexible member 30 is disposed on the supporting member 50 locating on the front surface of the first frame 21, the second frame 23 and the foldable device 22. The flexible member 30 is provided with a bendable area 31 corresponding to the foldable device 22 and two non-bendable areas 33 connected to two opposite sides of the bendable area 31. The two non-bendable areas 33 of the flexible member 30 can be fixed on the first frame 21 and the second frame 23, respectively. The bendable mechanism 25 is used to support the bendable area 31 of the flexible member 30, and the flexible member 30 is bent (folded) or unbent (flattened) along with the bendable mechanism 25. In the embodiment of the present disclosure, the bendable mechanism 25 is a hinge. Specifically, the bendable mechanism 25 includes a middle hinge assembly 250 and two connecting hinges 255 provided on the two opposite sides of the middle hinge assembly 250. Optionally, the bendable mechanism 25 may also be other mechanisms that can meet bending requirements, such as flexible belts, springs, soft rubber, flexible steel plates, rubber sheets, and the like. The shielding mechanism 29 includes a fixing member 291 connected to the middle hinge assembly 250, and a shielding member 295 connected between the fixing member 291 and the connecting hinge 255. During the bending and unbending process of the bendable mechanism 25, the shielding member 295 is rotated relative to the fixing member 291, and the shielding member 295 slides relative to the bendable mechanism 25 and covers the bendable mechanism 25. In this embodiment, the fixing member 291 is a strip-shaped fixing piece, and the shielding member 295 is a rectangular shielding piece. The fixing piece is connected to the back surface of the middle hinge assembly 250, and the two opposite sides of the fixing piece are respectively rotatably connected with shielding pieces, and the two shielding pieces are rotated relative to the fixing member 291 along with the bending or unbending of the bendable mechanism 25.

In this embodiment, the two opposite sides of the supporting member 50 are respectively fixedly connected to the connecting hinges 255 on the two opposite sides of the bendable mechanism 25.

Optionally, the supporting member 50 includes a first connection area 522, a second connection area 524, and a bendable area 526 located between the first connection area 522 and the second connection area 524. Optionally, the first connection area 522 and the second connection area 524 of the supporting member 50 are respectively connected to two connecting hinges 255. Optionally, the first connection area 522 and the second connection area 524 of the supporting member 50 are respectively fixed to two connecting hinges 255. Optionally, the length of the supporting member 50 can also be increased. The first connection area 522 of the supporting member 50 is connected to the connecting hinge 255 away from the second frame 23, and the second connection area 524 is connected to the second frame 23 and the connecting hinge 255 adjacent to the second frame 23. Optionally, the bendable area 526 of the supporting member 50 located between the two connecting hinges 255 is slidably connected to the middle hinge assembly 250. When the foldable device 22 is bent, the bendable area 526 of the supporting member 50 located between the two connecting hinges 255 slides relative to the middle hinge assembly 250. Optionally, when the foldable device 22 is bent, the two connecting hinges 255 both slide relative to the middle hinge assembly 250 in a direction toward to the middle hinge assembly 250, so as to reduce the drawing force of the supporting member 50 and make its length remain the same or basically remain the same. Due to the two connecting hinges 255, there is no need to add additional sliding compensation components, which can effectively save the space occupied by the foldable device 22.

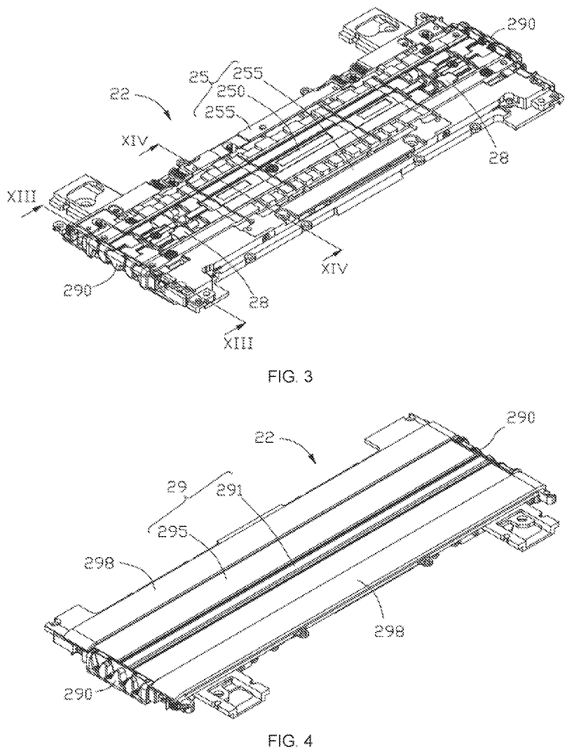

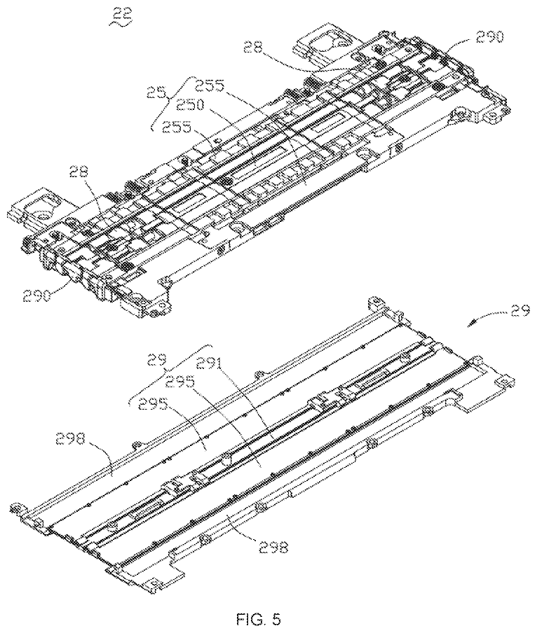

Optionally, as shown in FIGS. 3 and 5, a linkage mechanism 28 is provided between the middle hinge assembly 250 and the connecting hinge 255 of the bendable mechanism 25, and the bendable mechanism 25 enables the two connecting hinges 255 to move synchronously through the linkage mechanism 28, and the middle hinge assembly 250 also moves synchronously. Optionally, each connecting hinge 255 is located at the side portion of the middle hinge assembly 250 and can rotate and slide relative to the middle hinge assembly 250. In addition to the middle hinge assembly 250 and the linkage mechanism 28, the bendable mechanism 25 may also include other corresponding matching elements, such as a second shaft, screws, and the like. Optionally, when the bendable mechanism 25 is unbent (unfolded), the two shielding members 295 slide and rotate relative to the middle hinge assembly 250 to move away from each other. Optionally, when the bendable mechanism 25 is bent, the two shielding members 295 slide and rotate relative to the middle hinge assembly 250 to be close to each other.

The shielding mechanism 29 is arranged on the inner side of the bending of the bendable mechanism 25. Specifically, the fixing member 291 of the shielding mechanism 29 is connected to the middle hinge assembly 250, and the shielding member 295 is connected between the fixing member 291 and the corresponding connecting hinge 255. During the bending process of the bendable mechanism 25, the connecting hinge 255 can drive the corresponding shielding member 295 to slide relative to the bendable mechanism 25, the shielding member 295 is rotated relative to the fixing member 291, and the shielding mechanism 29 always at least partially covers the inner side of the bending of the bendable mechanism 25.

In this embodiment, the two connecting hinges 255 are movably arranged on the two opposite sides of the middle hinge assembly 250, the rotation axis between the shielding member 295 and the fixing member 291 is an imaginary axis (virtual axis), and the axis of the imaginary axis is spaced apart from and parallel to the bending axis of the bendable mechanism 25. When the bendable mechanism 25 is bent, the shielding member 295 is rotated relative to the middle hinge assembly 250 around the imaginary axis. Optionally, when the bendable mechanism 25 is bent or unbent, the connecting hinge 255 and the shielding member 295 are rotated around different axes. Optionally, the axis of the imaginary axis of the shielding member 295 and the axis of the connecting hinge 255 are located on different layers. Optionally, the axis of the connecting hinge 255 is closer to the flexible member 30 than the axis of the imaginary axis of the shielding member 295. Optionally, when the bendable mechanism 25 is unfolded, the shielding member 295 slides inward relative to the corresponding connecting hinge 255. Optionally, when the bendable mechanism 25 is bent, the shielding member 295 slides outward relative to the corresponding connecting hinge 255. Optionally, the unfolding state and the bending state are relative, and the unfolding state has a larger open angle than the bending state. Optionally, the unfolding state may be a flattening state, and the bending state may be a folding state.

In this embodiment, the front surface refers to the surface that is the same as the light emitting surface of the flexible screen, and the back surface refers to the surface facing away from the light emitting surface of the flexible screen. The electronic equipment 100 is, for example, but not limited to, mobile phones, tablet computers, displays, liquid crystal panels, OLED panels, TVs, smart watches, VR head-mounted displays, on-board displays, and any other product and component having display functions. The “connection” in the description of the embodiment of the present disclosure includes both direct connection and indirect connection. For example, the connection of A and B includes the direct connection of A and B or the connection through a third element C or more other elements. Connection also includes two cases: integrated connection and non-integrated connection. Integrated connection means that A and B are integrally formed and connected, and non-integrated connection means that A and B are not integrally formed and connected. Understandably, unless limited by modifiers, prefixes or suffixes, the “connection” mentioned in the embodiments of the present disclosure should be understood as including, but not limited to, fixed connection, rotating connection, sliding connection, pivot connection, screw connection, movable connection, interference connection, friction connection, elastic connection, rigid connection, glue connection, etc. It is understandable that the “fixing” mentioned in the embodiment of the present disclosure is not limited to the direct fixation of two elements, but can be fixation by third-party elements or more elements. Understandably, the various specific connection relationships, such as “rotating connection”, “sliding connection”, “rotating connection”, “elastic connection”, “rigid connection”, “fixed connection”, “movable connection”, “pivot connection”, and “screw connection” mentioned in the present disclosure are not limited to the direct connection of two elements, but can be connection through a third-party element or more other elements, unless it is clearly specified that the two elements are directly connected.

The foldable device 22 of the electronic equipment 100 of the present disclosure includes a bendable mechanism 25 and a shielding mechanism 29 arranged on the back surface of the bendable mechanism 25. The shielding mechanism 29 includes a fixing member 291 connected to the middle hinge assembly 250 and a shielding member 295 rotatably connected to the fixing member 291, the bendable mechanism 25 drives the shielding member 295 to rotate relative to the fixing member 291 when bending; because the shielding mechanism 29 is arranged on the inner side of the bending of the bendable mechanism 25, and bent or unbent along with the bendable mechanism 25, and the shielding member 295 always covers at least part of the inner side of the bending of the bendable mechanism 25 to prevent dust and other impurities from entering the foldable device 22 from the inner side of the bending.

In this embodiment, the linkage mechanism 28 is connected between the middle hinge assembly 250 and the connecting hinge 255. When the connecting hinge 255 on one side is rotated, the linkage mechanism 28 drives the connecting hinge 255 on the other side to rotate, so that the linkage of the bendable mechanism 25 is realized.

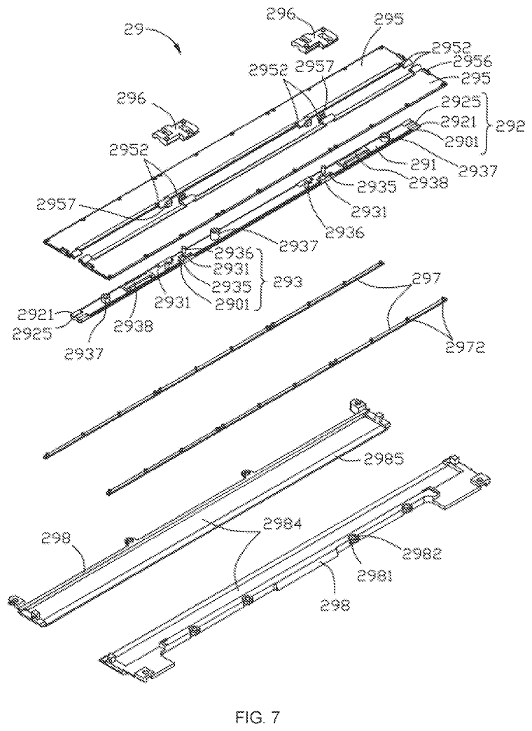

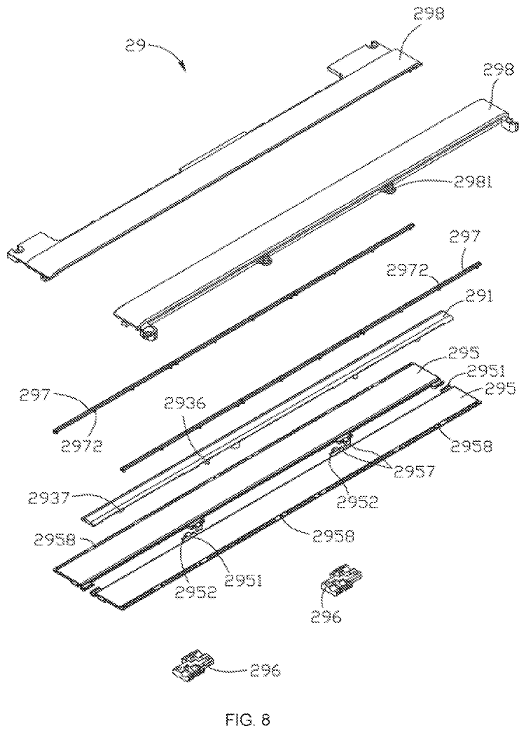

Please refer to FIGS. 7 to 9 together, the shielding member 295 is matched with the fixing member 291 through an arc surface, so that the shielding member 295 is rotated relative to the fixing member 291. The two opposite ends of the fixing member 291 are respectively provided with a first connecting portion 292, and the middle portion of the fixing member 291 is provided with a second connecting portion 293; and the shielding member 295 is rotatably connected to the fixing member 291 through the first connecting portion 292 and the second connecting portion 293. Specifically, two opposite ends of the side of the fixing member 291 facing the middle hinge assembly 250 are respectively provided with a first connecting portion 292, and the middle portion is provided with two second connecting portions 293 spaced apart from each other; and the shielding member 295 is rotatably connected to the fixing member 291 through the first connecting portions 292 and the second connecting portions 293, that is, the first connecting portion 292 and the second connecting portion 293 are both provided with arc surfaces, and the shielding member 295 is also provided with arc surface. The arc surfaces cooperate with each other to realize the rotation of the shielding member 295 relative to the fixing member 291. It can be understood that the shielding member 295 may be rotatably connected to the fixing member 291 by other means such as the cooperation of a shaft and a hole.

Optionally, the first rotating part is provided with a first arc surface. In this embodiment, the fixing member 291 is provided with a first arc surface; and the second rotating part is provided with a second arc surface that matches the first arc surface. In this embodiment, the shielding member 295 is provided with a second arc surface that matches the first arc surface, and the axis of the first arc surface and the imaginary axis between the shielding member 295 and the fixing member 291 are collinear. Optionally, the axis of the second arc surface is also collinear with the imaginary axis. In this embodiment, the fixing member 291 is located between the two shielding members 295, the first connecting portion 292 of the fixing member 291 includes first arc surfaces 2921 provided on the two opposite sides of the fixing member 291, and the second connecting portion 293 of the fixing member 291 includes first arc surfaces 2931 provided on the two opposite sides of the fixing member 291, and second arc surfaces 2951 are provided on each shielding member 295 corresponding to the first arc surfaces 2921 of the first connecting portion 292 and the first arc surfaces 2931 of the second connecting portion 293, and each second arc surface 2951 is rotatably matched with the corresponding first arc surfaces 2921 and 2931.

Optionally, the first rotating part includes a connecting bar 2901. Specifically, the side wall of the fixing member 291 is provided with a connecting bar 2901, and the first arc surfaces 2921, 2931 are provided on the connecting bars 2901. The second rotating part includes an extension piece 2952. Specifically, the shielding member 295 is provided with an extension piece 2952 corresponding to the connecting bar 2901, and the second arc surface 2951 is provided on the extension piece 2952. Specifically, each first connecting portion 292 includes connecting bars 2901 arranged on the two opposite sides of the fixing member 291, and the first arc surface 2921 is arranged on the front surface of each connecting bar (strip) 2901, that is, the side of the connecting bar 2901 facing the middle hinge assembly 250 is provided with a first arc surface 2921; each second connecting portion 293 includes connecting bars 2901 provided on the two opposite sides of the fixing member 291, and the first arc surface 2931 is provided on the front surface of the first connecting bar 2901, that is, the side of the connecting bar 2901 facing the middle hinge assembly 250 is provided with a first arc surface 2931. Each extension piece 2952 is in an arc-shaped sheet structure, and the extension piece 2952 extends from the side wall of the shielding member 295 outwardly in a curved manner. Specifically, the protrusion direction of the extension piece 2952 faces the front surface of the flexible member 30. The second arc surface 2951 is provided on the curved inner side of each extension piece 2952, that is, the second arc surface 2951 is provided on the back surface of each extension piece, i.e., the side of each extension piece 2952 facing the fixing member 291.

Optionally, the fixing member 291 includes a first rotating part, the shielding member 295 includes a second rotating part rotatably connected to the first rotating part, and the shielding member 295 and the fixing member 291 are rotatably connected through the cooperation of the first rotating part and the second rotating part. In this embodiment, the first rotating part includes a connecting bar 2901 and a positioning member 296, and the second rotating part includes an extension piece 2952 and a stop block 2957.

Optionally, the first rotating part includes a blocking part 2966, and the second rotating part includes a stop block 2957, and the stop block 2957 and the blocking part 2966 cooperate to prevent the shielding member 295 from over-rotating when rotating relative to the bendable mechanism 25. The over-rotating means that the shielding member 295 rotates relative to the bendable mechanism 25 to be disconnected from the corresponding fixing member 291.

Optionally, during the bending process of the bendable mechanism 25, the shielding member 295 also rotates relative to the corresponding connecting hinge.

Optionally, during the bending process of the bendable mechanism 25, the rotation angle of the shielding member 295 relative to the corresponding connecting hinge first increases and then decreases.

Optionally, a receiving groove is provided on the fixing member 291 corresponding to the extension piece 2952, and when the bendable mechanism 25 is in a bending state, a part of the extension piece 2952 is accommodated in the receiving groove. Specifically, each first connecting portion 292 is provided with a first receiving groove 2925 adjacent to each first arc surface 2921, and each second connecting portion 293 is provided with a second receiving groove 2935 adjacent to each first arc surface 2931, when the bending mechanism 25 is in a bending state, the extension pieces 2952 of the shielding member 295 are respectively accommodated in the corresponding first receiving groove 2925 and the second receiving groove 2935.

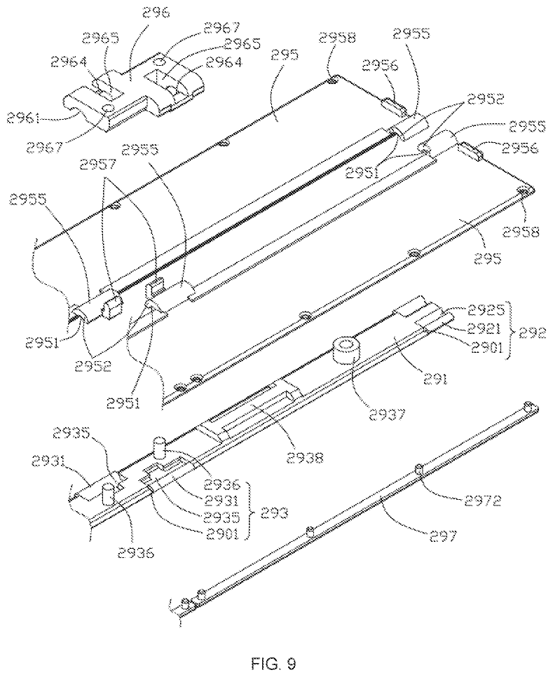

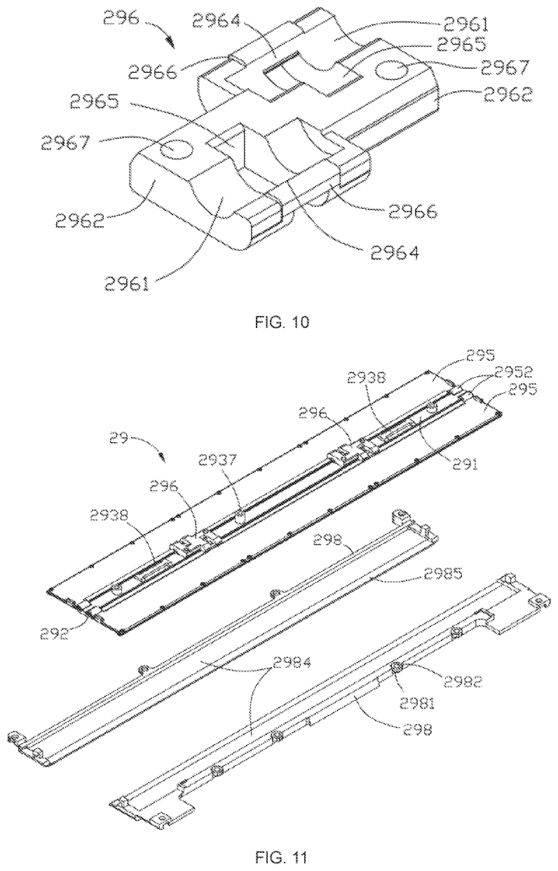

As shown in FIGS. 9 and 10, the first rotating part further includes a positioning member 296. Specifically, the shielding mechanism 29 further includes a positioning member 296. The positioning member 296 at least partially covers the extension piece 2952 and is connected to the fixing member 291. The positioning member 296 and the extension piece 2952 are matched through an arc surface, and the extension piece 2952 is rotated relative to the positioning member 296 during the bending or unbending process of the bendable mechanism 25. In this embodiment, each second connecting portion 293 of the fixing member 291 is connected with a positioning member 296, and each positioning member 296 at least partially covers the extension pieces 2952 corresponding to the two shielding members 295 and is connected to the second connecting portion 293 corresponding to the fixing member 296. The connection between the positioning member 296 and the first connecting portion 292 may adopt a clamping connection, a screw connection, an adhesive connection or other connection methods.

The positioning member 296 is provided with a rotating groove corresponding to the extension piece 2952, and the extension piece 2952 is provided with a third arc surface 2955 facing away from the second arc surface 2951, wherein the third arc surface 2955 is coaxial with the second arc surface 2951, and an inner surface of the rotating groove of the positioning member 296 is a fourth arc surface 2961 rotatably fitted to the third arc surface 2955. Optionally, the rotating groove and the second receiving groove 2935 of the second connecting portion 293 form a movement space, and the extension piece 2952 of the shielding member 295 can rotate in the movement space. Specifically, the rotating grooves are provided on the two opposite sides of the positioning member 296. The positioning member 296 includes two positioning blocks 2962 respectively at least partially covering the extension pieces 2952 of the two shielding members 295, and a positioning block 2962 is correspondingly extended from the side of the positioning member 296 where the rotating groove is provided. In this embodiment, the two positioning blocks 2962 are fixedly connected in one piece. Optionally, the two positioning blocks 2962 can be arranged separately. The rotating groove is provided on the side of the corresponding positioning block 2962 facing the fixing member 291, and the inner surface of the rotating groove is a fourth arc surface 2961.

Furthermore, a stop block 2957 is provided on the extension piece 2952. Specifically, a stop block 2957 is provided on the extension piece 2952 corresponding to the second connecting portion 293. The positioning member 296 is provided with a blocking part 2966 corresponding to the stop block 2957. When the bendable mechanism 25 is in the bending state, the stop block 2957 is blocked by the blocking part 2966 to prevent the shielding member 295 from being separated from the fixing member 291. The positioning member 296 also includes a through groove 2965 to be inserted by the stop block 2957. Specifically, each positioning block 2962 is provided with a through groove 2965, and the through groove 2965 penetrates through the corresponding rotating groove, that is, through the corresponding fourth arc surface 2961, the positioning block 2962 is provided with a blocking part 2966 at the end of the through groove 2965. Specifically, the blocking part 2966 is a blocking strip. The blocking part 2966 includes a blocking surface 2964 provided on a side of the blocking part 2966 facing the through groove 2965. The stop block 2957 extends outwardly from the side of the extension piece 2952 away from the shielding member 295 by a certain length, and then extends to the side away from the fixing member 291. Specifically, the stop block 2957 extends outwardly from the side of the extension piece 2952 away from the shielding member 295 by a certain length, and then extends to the front surface of the fixing member 291. In this embodiment, the stop block 2957 is L-shaped. It is understandable that the stop block 2957 may also be of other shapes that can be matched with the blocking part 2966, which is not limited here.

In this embodiment, the fixing member 291 is provided with a connecting post 2936, the positioning member 296 is provided with a connecting hole 2967, and the connecting post 2936 is inserted into the connecting hole 2967 to connect the positioning member 296 with the fixing member 291. Specifically, the second connecting portion 293 of the fixing member 291 further includes two connecting posts 2936. The two connecting posts 2936 are located on the two opposite sides of the second connecting portion 293. The two opposite ends of the positioning member 296 are respectively provided with connecting holes 2967. The two connecting posts 2936 are respectively clamped in the two connecting holes 2967, so that the positioning member 296 and the fixing member 291 are fixedly connected.

In other embodiments, the positioning member 296 is provided with a connecting post, and the fixing member 291 is provided with a connecting hole, and the connecting post is inserted into the connecting hole to connect the positioning member 296 with the fixing member 291.

Optionally, the fixing member 291 is connected to the middle hinge assembly 250 by screwing, clamping or gluing. In this embodiment, the side of the fixing member 291 facing the middle hinge assembly 250 is provided with several connecting posts 2937, and each connecting post 2937 is provided with a connecting hole along its axial direction, and the locking member passes through the middle hinge assembly 250 and then is locked in the connecting hole of the corresponding connecting post 2937, so that the fixing member 291 is fixedly connected to the middle hinge assembly 250.

Optionally, several reinforcing ribs 2938 are provided on the fixing member 291 to make the fixing member 291 firmer; specifically, a reinforcing rib 2938 is provided between each second connecting portion 293 and first connecting portion 292 on the fixing member 291.

Optionally, the end portion of the shielding member 295 is provided with a shielding step 2956, and the shielding step 2956 is used to shield light.

The shielding mechanism 29 further includes a covering member 298 connected to the connecting hinge 255, and the shielding member 295 is slidably inserted between the connecting hinge 255 and the covering member 298 on a side away from the fixing member 291. Specifically, the covering member 298 is a rectangular plate, and the covering member 298 can be screwed, clipped or glued to the side of the corresponding connecting hinge 255 facing away from the flexible member 30, a gap is provided between the covering member 298 and the corresponding connecting hinge 255, and the side of the shielding member 295 away from the fixing member 291 can be slidably accommodated in the gap. In this embodiment, the side of the covering member 298 away from the fixing member 291 is provided with several connecting lugs 2981, and each lug 2981 is provided with a through hole 2982.

Optionally, the side of the covering member 298 facing the connecting hinge 255 is provided with a slide guiding groove 2984, and the shielding member 295 is slidably received in the slide guiding groove 2984. Preferably, the covering member 298 is provided with a slide guiding surface 2985 on the side of the inner surface of the slide guiding groove 2984 away from the lug 2981, and the slide guiding surface 2985 facilitates the sliding-in of the shielding member 295.

Optionally, a wear strip 297 is provided on the side of the shielding member 295 away from the fixing member 291, and the wear strip 297 is provided between the shielding member 295 and the corresponding covering member 298, and the wear strip 297 is used to prevent the shielding member 295 from being worn out when sliding relative to the corresponding covering member 298. Specifically, the shielding member 295 is closer to the flexible member 30 than the corresponding covering member 298, and the side of the shielding member 295 away from the fixing member 291 is stacked with the corresponding covering member 298, wherein the wear strip 297 is disposed between the shielding member 295 and the corresponding covering member 298 and spaces the shielding member 295 and the corresponding covering member 298 apart. The wear strip 297 may be connected to the shielding member 295 by means of clamping, gluing, or screwing. In this embodiment, the side of each shielding member 295 facing away from the extension piece 2952 is provided with several fixing holes 2958, and the several fixing holes 2958 extend along the length direction of the shielding member 295; the wear strip 297 is provided with several fixing posts 2972 along its length direction, and the several fixing posts 2972 of the wear strip 297 are respectively inserted into the corresponding fixing holes 2958 of the shielding member 295, so that the wear strip 297 is fixedly connected to the shielding member 295.

When the foldable device 22 is in the unbending state, the area of the overlapping region of the shielding member 295 and the corresponding covering member 298 is the first area; when the foldable device 22 is in the bending state, the area of the overlapping region of the shielding member 295 and the corresponding covering member 298 is the second area, wherein the first area is smaller than the second area. In other words, when the foldable device 22 is switched from the unbending state to the bending state, the area of the overlapping region gradually increases; on the contrary, when the foldable device 22 is switched from the bending state to the unbending state, the area of the overlapping region gradually decreases. The wear strip 297 is disposed in the overlapping region of the shielding member 295 and the corresponding covering member 298. Optionally, when the foldable device 22 is in the unbending state, the distance between the shielding member 295 and the corresponding covering member 298 is the first distance; when the foldable device 22 is in the bending state, the distance between the shielding member 295 and the corresponding covering member 298 is the second distance, where the first distance is smaller than the second distance; that is, during the bending process of the foldable device 22, the wear strip 297 keeps the opposite surfaces of the shielding member 295 and the covering member 298 spaced apart.

Optionally, the slide guiding groove 2985 is used for the wear strip 297 to slide. Specifically, the thickness of the covering member 298 corresponding to the position where the slide guiding surface 2985 is provided is smaller than the thickness at other positions of the covering member 298, that is, the slide guiding surface 2985 is inclined from the front surface to the back surface of the covering member 298. When the foldable device 22 is switched from the unbending state to the bending state, the area of the overlapping region between the shielding member 295 and the covering member 298 gradually increases, and the wear strip 297 slides on the slide guiding surface 2985 and pushes the covering member 298 away from the shielding member 295 toward the back surface of the flexible member 30, relative to the shielding member 295.

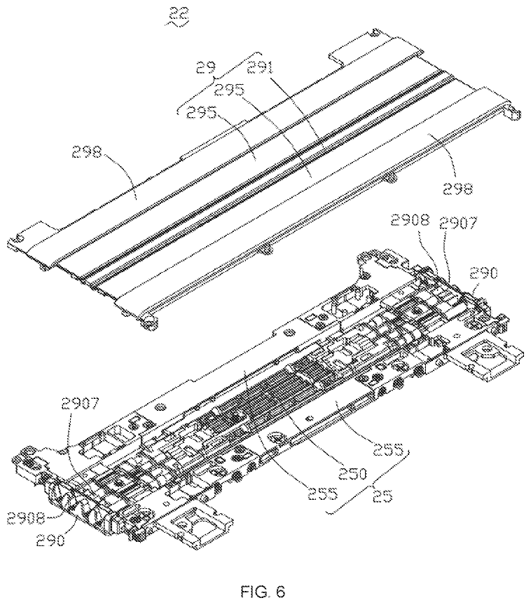

As shown in FIG. 6, the shielding mechanism 29 also includes two end portion shielding mechanisms 290 arranged at the two opposite ends of the bendable mechanism 25. Each end portion shielding mechanism 290 is bent or unbent along with the bendable mechanism 25, and the end portion shielding mechanism 290 always shields the end portion of the bendable mechanism 25 to prevent dust and other impurities from entering the foldable device 22 from the end portion. Each first shielding mechanism 290 is in a chain-like structure in which several shielding units are sequentially connected. The side of the shielding unit in the middle facing the middle hinge assembly 250 is provided with a supporting block 2907. The supporting block 2907 is used to support the covering member 291 and the shielding member 295; specifically, the supporting block 2907 is provided with two accommodating grooves 2908 spaced in parallel, and the two accommodating grooves 2908 are used for accommodating the extension pieces 2952 at the same ends of the two shielding members 295, that is, the inner surface of each accommodating groove 2908 slidably fits with the third arc surface 2955 of the corresponding extension piece 2952.

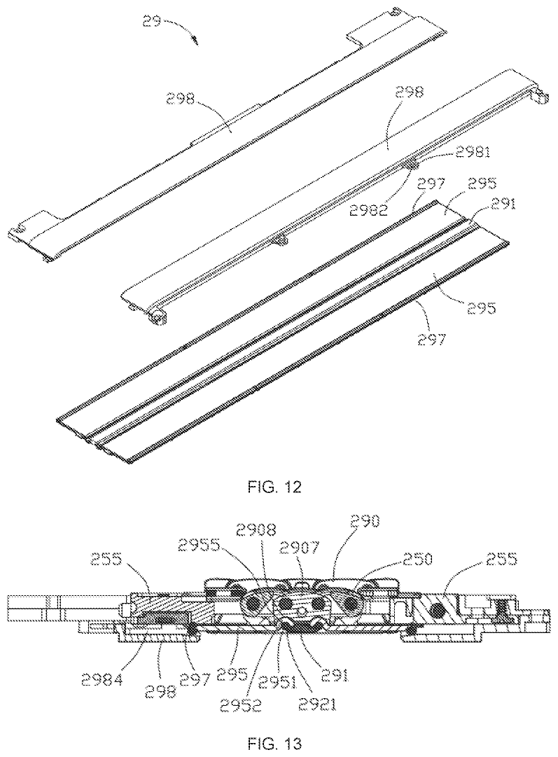

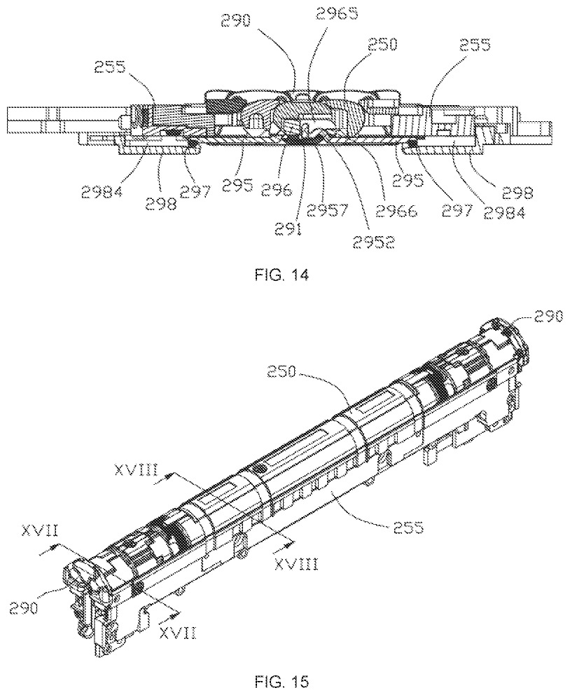

Please refer to FIGS. 3 to 14 together, when assembling the shielding mechanism 29, the two shielding members 295 are placed on the two opposite sides of the fixing member 291, specifically, the second arc surfaces 2951 of the extension pieces 2952 at both ends of each shielding member 295 are rotatably attached to the first arc surfaces 2921 corresponding to the fixing member 291, and the second arc surface 2951 of the extension piece 2952 in the middle of the shielding member 295 is rotatably attached to the first arc surface 2931 corresponding to the fixing member 291; the two positioning members 296 are respectively covered on the extension pieces 2952 in the middle of the two shielding members 295 and respectively connected to the first connecting portion 293 corresponding to the fixing member 291; specifically, the fourth arc surface 2961 of the positioning member 296 slidably fits with the third arc surface 2955 of the corresponding extension piece 2952, the stop block 2957 is received in the corresponding through groove 2965, and each connecting post 2936 is clamped to the connecting hole 2967 corresponding to the positioning member 296, so that the two shielding members 295 are rotatably connected to the two opposite sides of the fixing member 291. The fixing member 291 is connected to the middle of the back surface of the middle hinge assembly 250, that is, the fixing member 291 extends along the bending axis direction of the bendable mechanism 25, and several locking members pass through the middle hinge assembly 250 and then are locked to the connecting holes of the connecting posts 2937, so that the fixing member 291 is fixedly connected to the middle of the back surface of the middle hinge assembly 250. The two covering members 298 are respectively connected to the back portions of the two connecting hinges 255, each covering member 298 extends along the bending axis direction of the bendable mechanism 25, and the slide guiding groove 2984 of the covering member 298 faces the middle hinge assembly 250. Several locking members respectively pass through the through holes 2982 of the connecting lugs 2981 and are locked to the connecting hinges 255, so that the side of each shielding member 295 away from the fixing member 291 is slidably received in the corresponding slide guiding groove 2984.

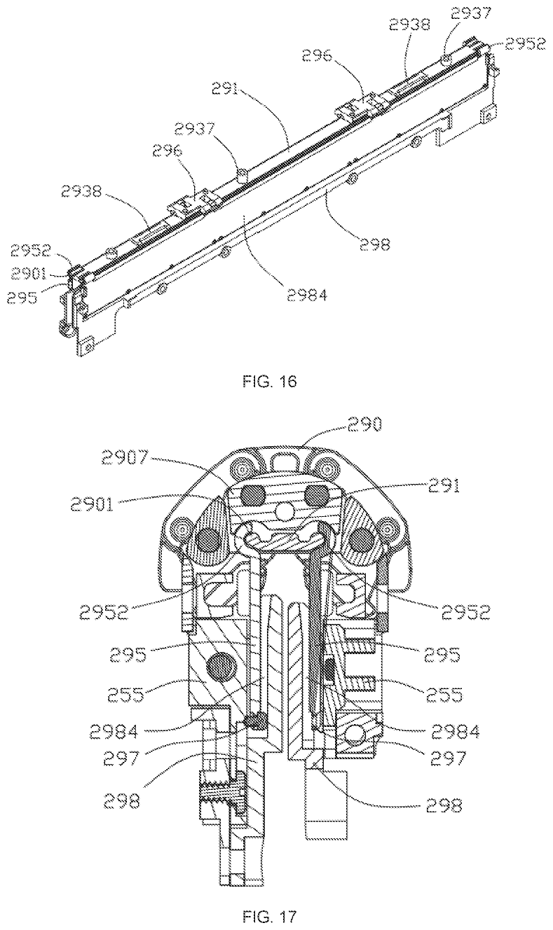

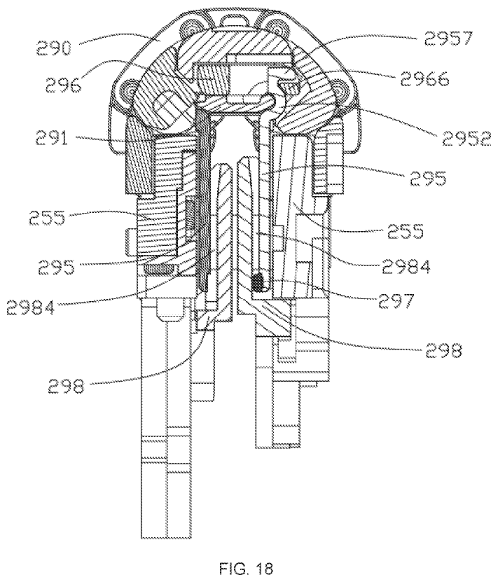

Please refer to FIGS. 13 to 18 together, when the foldable device 22 is bent, one of the connecting hinges 255 is rotated toward the other connecting hinge 255, and the linkage mechanism 28 drives the other connecting hinge 255 to also synchronously rotate toward one of the connecting hinges 255; the two connecting hinges 255 respectively drive the two shielding members 295 to slide in the corresponding slide guiding grooves 2984; that is, each shielding member 295 is slidably inserted into the slide guiding groove 2984, and each shielding member 295 rotates relative to the fixing member 291. Specifically, the second arc surface 2951 of the extension piece 2952 is rotatably fitted to the first arc surface 2921 and 2931, and the third arc surface 2955 of the extension piece 2952 is rotatably fitted to the fourth arc surface 2961 of the corresponding positioning block 2962; the stop block 2957 rotates in the corresponding through groove 2965 until the stop block 2957 is blocked by the corresponding blocking part 2966. At this time, the bendable mechanism 25 is in a bending state, and the shielding member 295 always covers the back surface of the bendable mechanism 25 during the rotation, to prevent dust and other sundries from entering the foldable device 22 from the back surface, and the stop block 2957 can prevent the shielding member 295 from separating from the fixing member 291.

When the foldable device 22 is unbent, one of the connecting hinges 255 is rotated away from the other connecting hinge 255, and the linkage mechanism 28 drives the other connecting hinge 255 to also synchronously rotate away from one of the connecting hinges 255; the two connecting hinges 255 respectively drive the two shielding members 295 to slide in the corresponding slide guiding grooves 2984; that is, each shielding member 295 slides out of the slide guiding groove 2984, and each shielding member 295 rotates relative to the fixing member 291. That is to say, the second arc surface 2951 of the extension piece 2952 is rotatably fitted to the first arc surface 2921 and 2931, and the third arc surface 2955 of the extension piece 2952 is rotatably fitted to the fourth arc surface 2961 of the corresponding positioning block 2962; and the stop block 2957 rotates in the corresponding through groove 2965 to be away from the blocking part 2966, until the bendable mechanism 25 is in an unbending state, and the shielding member 295 always covers the back surface of the bendable mechanism 25 during the unbending process, to prevent dust and other sundries from entering the foldable device 22 from the back surface.

When the connecting hinge 255 is moved relative to the middle hinge assembly 250, the shielding member 295 slides relative to the connecting hinge 255; specifically, when each connecting hinge 255 rotates and slides relative to the middle hinge assembly 250, the shielding member 295 connected between the connecting hinge 255 and the fixing member 291 slides relative to the connecting hinge 255, and the shielding member 295 rotates relative to the fixing member 291.

Preferably, the movement of the connecting hinge 255 relative to the middle hinge assembly 250 includes rotation relative to the middle hinge assembly 250 and sliding relative to the middle hinge assembly 250, and the connecting hinge 255 rotates relative to the middle hinge assembly 250 while sliding relative to the middle hinge assembly 250.

In other ways of use, the two connecting hinges 255 can also be rotated together in directions toward each other. Since the middle hinge assembly 250 and the two connecting hinges 255 are connected by the linkage mechanism 28, the two connecting hinges 255 simultaneously drive the two shielding members 295 to rotate, so that the two shielding members 295 are close to each other, resulting in that the two connecting hinges 255 are close to each other synchronously to make the foldable device 22 bent.

When the foldable device 22 is unbent from the bending state, one of the connecting hinges 255 is rotated away from the other connecting hinge 255, and the linkage mechanism 28 drives the other connecting hinge 255 to also synchronously rotate away from one of the connecting hinges 255; the two connecting hinges 255 respectively drive the two shielding members 295 to slide in the corresponding slide guiding grooves 2984; that is, each shielding member 295 slides out along the corresponding slide guiding groove 2984, and each shielding member 295 rotates relative to the fixing member 291. That is to say, the second arc surface 2951 of the extension piece 2952 is rotatably fitted to the first arc surface 2921 and 2931, and the third arc surface 2955 of the extension piece 2952 is rotatably fitted to the fourth arc surface 2961 of the corresponding positioning block 2962; and the stop block 2957 is disconnected from the blocking part 2966 and rotates in the corresponding through groove 2965, until the bendable mechanism 25 is in a completely unbending state. The shielding member 295 always covers the back surface of the bendable mechanism 25 during the unbending process to prevent dust and other sundries from entering the foldable device 22 from the back surface. The stop block 2957 can prevent the shielding member 295 from separating from the fixing member 291.

In other ways of use, the two connecting hinges 255 can also be rotated together in reverse directions. Since the middle hinge assembly 250 and the two connecting hinges 255 are connected by the linkage mechanism 28, the two connecting hinges 255 simultaneously drive the two shielding members 295 to rotate, so that the two shielding members 295 are away from each other, resulting in that the two connecting hinges 255 are close to each other synchronously to make the foldable device 22 bent.

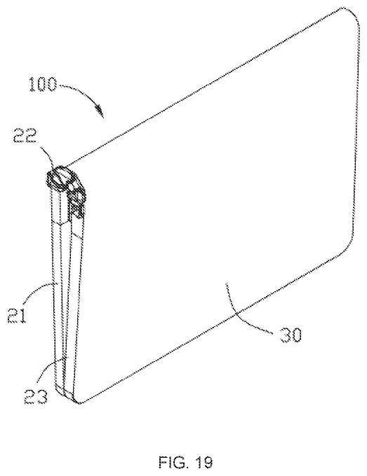

Please refer to FIGS. 1 to 4 and 19 together, the mounted foldable device 22 is placed between the first frame 21 and the second frame 23, and the two lugs of one of the connecting hinges 255 are respectively received in the first frame 21, and the other connecting hinge 255 is connected to the second frame 23. The front surface of the foldable device 22 is coplanar with the front surface of the first frame 21 and the front surface of the second frame 23. One end of the supporting sheet 50 is fixed to the first frame 21, and the other end is fixed to the second frame 23. The part between the two ends covers a part of the foldable device 22 and can slide relative to the part of the foldable device 22. One end of the flexible screen 30 is fixed to one end of the supporting sheet 50, and the other end is fixed to the first frame 21, and the part between the two ends covers the corresponding part of the supporting sheet 50 and can slide relative to the corresponding part of the supporting sheet 50.

When the electronic equipment 100 is bent, a bending force is applied to at least one of the first frame 21 and the second frame 23 of the electronic equipment 100 to make the connecting hinge 255 connected to the first frame 21 and the connecting hinge 255 connected to the second frame 23 rotated in mutually adjacent directions, to realize the bending of the foldable device 22, so that the bendable area 31 of the flexible member 30 is bent. Specifically, if a bending force is applied to the first frame 21, the first frame 21 drives the corresponding connecting hinge 255 to rotate relative to the middle hinge assembly 250 toward the side away from the flexible member 30; the linkage mechanism 28 drives the connecting hinge 255 connected to the second frame 23 to also synchronously rotate to the side away from the flexible member 30; and the two connecting hinges 255 respectively drive the two shielding members 295 to slide in the corresponding slide guiding grooves 2984, that is, each shielding member 295 is slidably inserted into the slide guiding groove 2984, and each shielding member 295 rotates relative to the fixing member 291. That is to say, the second arc surface 2951 of the extension piece 2952 is rotatably fitted to the first arc surface 2921 and 2931, and the third arc surface 2955 of the extension piece 2952 is rotatably fitted to the fourth arc surface 2961 of the corresponding positioning block 2962; the stop block 2957 rotates in the corresponding through groove 2965 until the stop block 2957 is blocked by the corresponding blocking part 2966. At this time, the bendable mechanism 25 is in a bending state, until the back surfaces of the first frame 21 and the second frame 23 are attached, and the shielding member 295 always covers the back surface of the bendable mechanism 25 during the rotation, to prevent dust and other sundries from entering the foldable device 22 from the back surface.

At this time, the foldable device 22 is bent, and the flexible member 30 is bent along with the foldable device 22, so that the middle hinge assembly 250 is connected to the front surfaces of the first connecting hinge 254 and the second connecting hinge 257, to form an arched arc surface to facilitate the fitting of the flexible member 30.

During the bending process of the foldable device 22, each shielding mechanism 29 is bent as the foldable device 22 is bent. Specifically, the shielding member 295 slides along with the bendable mechanism 25 relative to the corresponding connecting hinge 255 and rotates relative to the fixing member 291, and the shielding member 295 is always movably connected between the connecting hinge 255 and the fixing member 291, to prevent dust and other impurities from entering the foldable device 22 from the opposite back portions of the electronic equipment 100; at the same time, several shielding units of the end portion shielding mechanism 290 are bent along the foldable device 22, so that the several shielding units overlap each other to prevent dust and other impurities from entering the foldable device 22 from the two opposite ends of the electronic equipment 100.

In other bending methods of the electronic equipment 100, the bending force can also be applied to the first frame 21 and the second frame 23 at the same time, and the first frame 21 and the second frame 23 respectively drive two connecting hinges 255 to rotate relative to the side away from the flexible member 30, so as to realize the bending of the electronic equipment 100 through the foldable device 22.

When the electronic equipment 100 needs to be unbent, the first frame 21 or the second frame 23 is pulled outward, so that the connecting hinge 255 connected to the first frame 21 and the connecting hinge 255 connected to the second frame 23 are rotated in directions away from each other. Specifically, an outward unfolding force is applied to at least one of the first frame 21 and the second frame 23 of the electronic equipment 100, so that the connecting hinge 254 connected to the first frame 21 and the connecting hinge 255 connected to the second frame 23 are rotated in directions away from each other. For example, an outward unfolding force is applied to the first frame 21 to drive the connecting hinge 255 to rotate, and the linkage mechanism 28 drives the connecting hinge 255 connected to the second frame 23 to also rotate synchronously away from the first frame 21, the two connecting hinges 255 respectively drive the two shielding members 295 to slide in the corresponding slide guiding groove 2984, that is, each shielding member 295 slides along the corresponding slide guiding groove 2984, and each shielding member 295 is rotated relative to the fixed member 291, the stop block 2957 is disconnected from the blocking part 2966 and rotates in the corresponding through groove 2965 until the bendable mechanism 25 is in a completely unbending state. The shielding member 295 always covers the back surface of the bendable mechanism 25 during the unbending process to prevent dust and other sundries from entering the foldable device 22 from the back surface. The stop block 2957 can prevent the shielding member 295 from separating from the fixing member 291. The bendable area 31 of the flexible member 30 is unbent with the foldable device 22.

In other unbending methods of the electronic equipment 100, it is also possible to apply an outward unfolding force only to the second frame 23, and the second frame 23 implements the unbending of the electronic equipment 100 through the foldable device 22.

In other bending methods of the electronic equipment 100, it is also possible to apply an outward unfolding force to the first frame 21 and the second frame 23 at the same time, and the first frame 21 and the second frame 23 respectively drive the corresponding connecting hinge 255 to rotate toward a side of the flexible member 30, to realize the unbending of the electronic device 100.

The above is the implementation of the embodiments of the present disclosure. It should be pointed out that for those of ordinary skill in the art, without departing from the principle of the embodiments of the present disclosure, several improvements and modifications can be made, and these improvements and modifications are also regarded as the protection scope of the present disclosure.

What is claimed is:

1. A foldable device, comprising a bendable mechanism and a shielding mechanism, wherein the bendable mechanism comprises a middle hinge assembly and a connecting hinge provided on a side portion of the middle hinge assembly, and the shielding mechanism comprises a fixing member connected to the middle hinge assembly and a shielding member arranged between the fixing member and the connecting hinge, wherein when the bendable mechanism is in a bending process and an unbending process, the shielding member rotates relative to the fixing member, the shielding member slides relative to a corresponding connecting hinge and at least a part of the shielding member covers the bendable mechanism.

2. The foldable device according to claim 1, wherein a rotation axis between the shielding member and the fixing member is an virtual axis, and the rotation axis is spaced apart from and parallel to a bending axis of the bendable mechanism, wherein when the bendable mechanism is bent, the shielding member rotates relative to the middle hinge assembly around the rotation axis.

3. The foldable device according to claim 1, wherein during the bending process of the bendable mechanism, the shielding member rotates relative to the corresponding connecting hinge.

4. The foldable device according to claim 1, wherein during the bending process of the bendable mechanism, an angle of rotation of the shielding member relative to the corresponding connecting hinge first increases and then decreases.

5. The foldable device according to claim 2, wherein the fixing member comprises a first rotating part, the shielding member comprises a second rotating part rotatably connected with the first rotating part, and the shielding member and the fixing member are rotatably connected to each other by a cooperation of the first rotating part and the second rotating part, wherein the first rotating part comprises a blocking part, the second rotating part comprises a stop block, and the stop block cooperates with the blocking part to prevent the shielding member from over-rotating when rotating relative to the bendable mechanism.

6. The foldable device according to claim 5, wherein the first rotating part is provided with a first arc surface, and the second rotating part is provided with a second arc surface that is fitted to the first arc surface, wherein an axis of the first arc surface is collinear with the rotation axis.

7. The foldable device according to claim 6, wherein the first rotating part comprises a connecting bar, the first arc surface is provided on the connecting bar, and the second rotating part comprises an extension piece corresponding to the connecting bar, and the second arc surface is provided on the extension piece.

8. The foldable device according to claim 7, wherein the fixing member is provided with a receiving groove corresponding to the extension piece, and when the bendable mechanism is in a bending state, a part of the extension piece is accommodated in the receiving groove.

9. The foldable device according to claim 7, wherein the first rotating part further comprises a positioning member, wherein the positioning member at least partially covers the extension piece, the positioning member is matched with the extension piece through an arc surface, and the extension piece rotates relative to the positioning member during the bending process or the unbending process of the bendable mechanism.

10. The foldable device according to claim 9, wherein the positioning member is provided with a rotating groove corresponding to the extension piece, and the extension piece is provided with a third arc surface facing away from the second arc surface, wherein the third arc surface is coaxial with the second arc surface, and an inner surface of the rotating groove of the positioning member is a fourth arc surface rotatably fitted to the third arc surface.

11. The foldable device according to claim 9, wherein the stop block is provided on the extension piece, the blocking part is provided on the positioning member, wherein when the bendable mechanism is in the bending state, the stop block stops or is adjacent to the blocking part to prevent the shielding member from over-rotating.

12. The foldable device according to claim 10, wherein the positioning member further comprises a through groove configured to be passed through by the stop block, wherein the through groove passes through the rotating groove, and the blocking part is disposed at an end of a side of the through groove close to the shielding member.

13. The foldable device according to claim 1, wherein an end portion of the shielding member is provided with a shielding step, wherein the shielding step is configured to shield light.

14. The foldable device according to claim 1, wherein the shielding mechanism further comprises a covering member connected to the connecting hinge, wherein a side of the shielding member away from the fixing member is slidably inserted between the connecting hinge and the covering member.

15. The foldable device according to claim 14, wherein a side of the covering member facing the connecting hinge is provided with a slide guiding groove, and the shielding member is slidably received in the slide guiding groove.

16. The foldable device according to claim 15, wherein a wear strip is provided on a side of the shielding member away from the fixing member, wherein the wear strip is located between the shielding member and a corresponding covering member, and the wear strip is configured to space the shielding member and the corresponding covering member apart.

17. The foldable device according to claim 16, wherein during the bending process of the foldable device, the wear strip keeps opposite surfaces of the shielding member and the covering member to be spaced apart.

18. The foldable device according to claim 16, wherein a thickness of at least a part area of the covering member gradually decreases in a direction toward the fixing member, and when the foldable device is switched from an unbending state to the bending state, the wear strip slides in the slide guiding groove and pushes the covering member away from the shielding member.

19. An electronic device, comprising a flexible member, a housing and a foldable device, wherein the foldable device comprises a bendable mechanism and a shielding mechanism, the bendable mechanism comprises a middle hinge assembly and a connecting hinge provided on a side portion of the middle hinge assembly, and the shielding mechanism comprises a fixing member connected to the middle hinge assembly and a shielding member arranged between the fixing member and the connecting hinge, wherein when the bendable mechanism is in a bending process and an unbending process, the shielding member rotates relative to the fixing member, the shielding member slides relative to a corresponding connecting hinge and at least a part of the shielding member covers the bendable mechanism; the housing comprises a first frame and a second frame, the foldable device is disposed between the first frame and the second frame, the flexible member is disposed on the housing and the foldable device, and the flexible member is bent or unbent with the foldable device.
